(19) United States
(12) Patent Application Publication
(10) Pub. No.: US 2023/0057073 A1
(43) Pub. Date: Feb. 23, 2023

(54) Augmented Reality Platform for Fan Engagement

(71) Applicant: Laron A. Walker, ATLANTA, GA (US)

(72) Inventor: Laron A. Walker, ATLANTA, GA (US)

(21) Appl. No.: 17/408,400

(22) Filed: Aug. 21, 2021

(51) Int. Cl. G06T 19/20; G06T 13/40; G06T 13/20; G06T 13/80; G06T 7/70; G06T 19/00

(52) U.S. Cl. CPC G06T 19/20; G06T 13/40; G06T 13/205; G06T 13/80; G06T 7/70; G06T 19/006; G06T 2219/024; G06T 2219/2016

(57) ABSTRACT

An augmented reality platform that enables fan engagement and new media opportunities is disclosed. The invention is comprised of a mobile device software application (app) leveraging augmented reality (AR), artificial intelligence (AI) and a cloud network. Users select on-screen character avatars and dance songs from pre-defined categories within the app and then begin dancing and recording themselves with the app. The app transfers user movements and their local environment to the app. AI algorithms sync user movements to the avatar along with their background (using AR) and users can see themselves dancing in character on their mobile device. Users can share avatar dances with friends and compete with each other in dance contests in real time with virtual currency rewards. Advertisers can also participate in the app and share advertisements, logos as well as promote merchandise to the users.

### CROSS-REFERENCE TO RELATED APPLICATIONS

This application claims the benefit of U.S. Provisional Patent Application No. U.S. 63/075,176 filed on 9-6-2020.

### Field of the Augmented Reality Platform

The present augmented reality platform generally relates to apps. More specifically, it relates to an augmented reality platform that enables fan engagement and new media opportunities.

### BACKGROUND

During the early 1950s, Alan Turing (a young British mathematician) was one of the first researchers to explore the mathematical possibility of artificial intelligence. Turing suggested that humans use available information as well as reason in order to solve problems and make decisions and wondered why computers could not do the same. Research was slow. During this time, computers lacked a key prerequisite for intelligence: they couldn't store commands—they could only execute them. In addition, the cost of leasing a computer to conduct such research cost $200,000 a month and only prestigious universities and big technology companies could afford them. Five years later, a logic program was designed to mimic the problem-solving skills of humans and was funded by the RAND Corporation. This program is considered by many to be the first artificial intelligence program and was presented at the Dartmouth Summer Research Project on Artificial Intelligence. In the 1970s computers could store more information and became faster, cheaper, and more accessible. Machine learning algorithms also improved and people got better at knowing which algorithm to apply to specific problems. However, weaknesses continued. The biggest problem was the lack of computational power to do anything substantial: computers simply couldn't store enough information or process it fast enough. In order to communicate, for example, one needs to know the meanings of many words and understand them in many combinations and the computing power was not ready.

In the 1980's, interest in AI was reignited by two sources: an expansion of the algorithmic toolkit, and a boost in private funding. During these years, researchers popularized ‘deep learning’ techniques which allowed computers to learn using experience data. ‘Expert systems which mimicked the decision making process of a human expert also emerged. This program would ask an expert in a field how to respond in a given situation, and once this was learned for virtually every situation, non-experts could receive advice from that program. Expert systems were widely used in industries. In 1997, reigning world chess champion and grand master Gary Kasparov was defeated by IBM's Deep Blue, a chess playing computer program. This highly publicized match was the first time a reigning world chess champion loss to a computer and served as a huge step towards an artificially intelligent decision making program. In the same year, speech recognition software, developed by Dragon Systems, was implemented on Windows computers. This was another great step forward in the direction of the spoken language interpretation endeavor. Kismet, a robot developed by Cynthia Breazeal was an AI system that recognized and displayed human emotions.

2015 was considered to be a landmark year for artificial intelligence as the number of software projects as ‘AI Google’ and ‘neural networks’ became available. These increases in affordable neural networks were due to a rise in cloud computing infrastructure and to an increase in research tools and datasets. Other examples of popular AI include Microsoft's development of a Skype system that automatically translates from one language to another and Facebook's system that can describe images to blind people. Around 2016, China greatly accelerated its government funding (given its large supply of data and its rapidly increasing research output) some observers believe it may be on track to becoming an ‘AI superpower.’

Augmented reality is different from AI in that it overlays images and animations over a user's direct environment. AR was first achieved by a cinematographer called Morton Heilig in 1957. He invented the Sensorama which delivered visuals, sounds, vibration and smell to the viewer. Of course, it wasn't computer controlled but it was the first example of an attempt at adding additional data to an experience. In 1968, Ivan Sutherland (an American computer scientist) invented the head-mounted display as a kind of window into a virtual world. In 1975, Myron Krueger, an American computer artist developed the first “virtual reality” interface called “Videoplace” which allowed its users to manipulate and interact with virtual objects and to do so in real-time. Steve Mann, a computational photography researcher, invented wearable computing in 1980 and the phrase virtual reality was coined by Jaron Lainer in 1989. Thomas P Caudell of Boeing later coined the phrase “augmented reality” in 1990. The first properly functioning AR system was believed to have developed at USAF Armstrong's Research Lab by Louis Rosenberg in 1992. This device was called ‘Virtual Fixtures’ and was an incredibly complex robotic system which was designed to compensate for the lack of high-speed 3D graphics processing power in the early 90s. Today, AR is much more powerful and has become an interactive experience of a real-world environment where the objects that reside in the real world are enhanced by computer-generated perceptual information, sometimes across multiple sensory modalities, including visual, auditory, haptic, somatosensory experiences. AR can be defined as a system that fulfills three basic features: a combination of real and virtual worlds, real-time interaction, and accurate 3D registration of virtual and real objects. The overlaid sensory information can be constructive (i.e. additive to the natural environment), or destructive (i.e. masking of the natural environment). This experience is seamlessly interwoven with the physical world such that it is perceived as an immersive aspect of the real environment. While AR and AI has been gaining popularity in many industrialized nations, little AI has been leveraged for use in dance entertainment—particularly those relating to mobile device applications.

### Summary of the Augmented Reality Platform

The device herein disclosed and described provides a solution to the shortcomings in the prior art through the disclosure of an augmented reality platform that enables fan engagement and new media opportunities. An object of the augmented reality platform is to allow users to see themselves as dancing avatars and/or dancing with fictional, on-screen character avatars. The software records a user's dance moves and overlays the dance directly onto an animated, on-screen character avatar using AI algorithms. The on-screen character avatar replicates the user's exact dance moves and the app generates a small video dance recording that is processed and streamed back to the user.

Another object of the augmented reality platform is to capture user dance moves and apply them to on-screen character avatars to build a choreography archive. The app uses pose detection algorithms to detect if a person is fully in frame and their dance moves are recorded with digital video using their own mobile device. Videos files are then sent to the cloud network's powerful servers for post processing to extract the motion capture data so that it can be applied to other avatars in the archives without taxing the user's hardware resources.

Another object of the augmented reality platform is to allow a user to overlay their dancing avatar directly into their immediate background environment using AR on their mobile device. For example, after a user in their living room selects their avatar and syncs their dance moves to the avatar, they then record their living room environment and the avatar is placed into their living room for the duration of the video dance recording. To fit the on-screen character avatar properly into the background, a user can pinch the on-screen character avatar to resize them as needed to create a realistic effect.

Another object of the augmented reality platform is to allow users to select a on-screen character avatar and dance song of their choice. For example, users can choose from popular cartoon characters and select dance songs from popular contemporary artists that are all prerecorded and stored on the app.

Another object of the augmented reality platform is to allow users to share their video dance recordings with other online friends. Once a video dance recording is created with via the application, the user also receives a sharable link of the video dance recording that they can post to their internal social feed to alert their followers. They can also share the video via text message, email or simply share post the link to existing social media platforms.

Another object of the augmented reality platform is to allow users to hold avatar dancing competitions. Multiple users can share dancing avatars, apply scores to each other's performances and the vote for the best performance. Winners can receive virtual currencies and rewards from the platform. The software also tracks the popularity of video dance recordings on a block chain by monitoring the number of likes, and how often a recording is shared between users. Video dance recordings are ranked and scored by the app. Users also have the option of applying for non-fungible token (NFT) rights to their popular recordings.

Another object of the augmented reality platform is to allow advertisers to post ad banners, links and marketing materials in order to gain greater awareness and exposure for their products within the software menus as video feeds and virtual objects within the video dance recordings.

Another object of the augmented reality platform is to leverage AI algorithms to predict which types of music is more likely to engage the user and compel them to produce more videos dance recordings. For example, a user regularly creates video dance recordings to rock ‘n’ roll music with a high tempo, with certain children dancing; the AI algorithm predicts that they are better suited to follow and like videos by followers and other platform users that post similar content with the same attributes.

Another object of the augmented reality platform is to use Geofencing to drive fan engagement. Users can drop ‘pins’ (location markers) on existing maps on their mobile devices and share said pins with other users in order to compel them to participate in dance challenges—similar to a virtual ‘flash mob’ event. When another user agrees to be part of dance challenge the AR features are unlocked and they can compete when the Geofencing detects they are in range of the pin. For instance a user drops a pin on the location of a local restaurant and sends the pin location to their fans. The fans visit the restaurant to record an AR avatar dance that is unlocked when they arrive.

Another object of the augmented reality platform is to allow users to tailor the app to their style of music for themselves, their friends, their followers and their fans. For example, a musician can develop a dance that only uses their music. They can then invite others to generate dances that feature only their music and specific dance styles during a challenge. This customization builds the artist's brand loyalty and enhances commercialization.

Another object of the augmented reality platform is to enhance on-screen character avatar customization and build the on-screen character avatar archives. Users can leverage the app to build full-body 3D, on-screen character avatar models from a character customizer, filled with stock body shapes, clothing and accessories. The combination of selections is saved as an on-screen character avatar, that can then be used in the application. Once the on-screen character avatar is created, any dance or animation that exists in the app can be applied to it by the user. Other customizations include allowing users to create on-screen character avatar meta-data(such as birth date, name, gender and other demographics etc.). Users can also earn credits by sharing video dance recordings to unlock custom on-screen character avatar items, effects and accessories such as clothing, jewelry etc.

Another object of the augmented reality platform is to use a virtual currency in combination with dance competitions as a form of ‘gamification’ of avatar dance challenges. Users record their dance videos, establish dance challenges and sell their dance videos using virtual currency (such as Ethereum, bit coin etc.) to friends so they can dance with their on-screen character avatars.

Another object of the augmented reality platform is to allow users to add audio sounds to their video dance recordings. The user leverages the microphone on their mobile devices to record and add audio (singing, rapping etc.) and overlay them onto the video dance recordings.

Another object of the augmented reality platform is to allow users to generate viral content in order to enhance their online social profile. Once a user creates a popular video dance recording and it gets shared exponentially, they then have an opportunity to establish themselves as ‘social influencers.’

Another object of the augmented reality platform is to allow users to engage physical exercise. As video dance recordings circulate amongst generations, the potential for dancing and physical exercise increases as users generate video dance recordings of their own and share them with others.

Another object of the augmented reality platform is to increase artist and label marketing and enhance viewership and exposure. In some instances, up-and-coming musicians and artists can upload dance songs to the app where they can be used in video dance recordings. If these video dance recordings go viral, an opportunity exists for independent artists to become more popular and provide future opportunities. Likewise if a label promoter offers dance songs to the platform they also have an opportunity to increase viewership and garner interest in a contract artist. In addition, the platform has

It is briefly noted that upon a reading this disclosure, those skilled in the art will recognize various means for carrying out these intended features of the augmented reality platform. As such it is to be understood that other methods, applications and systems adapted to the task may be configured to carry out these features and are therefore considered to be within the scope and intent of the present augmented reality platform, and are anticipated. With respect to the above description, before explaining at least one preferred embodiment of the herein disclosed augmented reality platform in detail, it is to be understood that the augmented reality platform is not limited in its application to the details of construction and to the arrangement of the components in the following description or illustrated in the drawings. The augmented reality platform herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present augmented reality platform. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present augmented reality platform, as well as the advantages thereof over existing prior art, which will become apparent from the description to follow, are accomplished by the improvements described in this specification and hereinafter described in the following detailed description which fully discloses the augmented reality platform, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a plan view of the augmented reality platform app with avatar character selection screen.

FIG. 2 shows a perspective view of a user creating a video dance recording of themselves.

FIG. 3 shows a perspective view of a user the AR and inserting an avatar character into their environment background.

FIG. 4 shows a plan view of the augmented reality platform app playing a completed, video dance recording.

FIG. 5 shows a plan view of the augmented reality platform app sharing a video dance recording.

FIG. 6 shows a representative view of the augmented reality platform's methods.

FIG. 7 shows a representative view of the augmented reality platform's methods.

FIG. 8 shows a representative view of the augmented reality platform process.

Other aspects of the present augmented reality platform shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the augmented reality platform are elements that are well-known in the prior art and will not be discussed in detail for this disclosure.

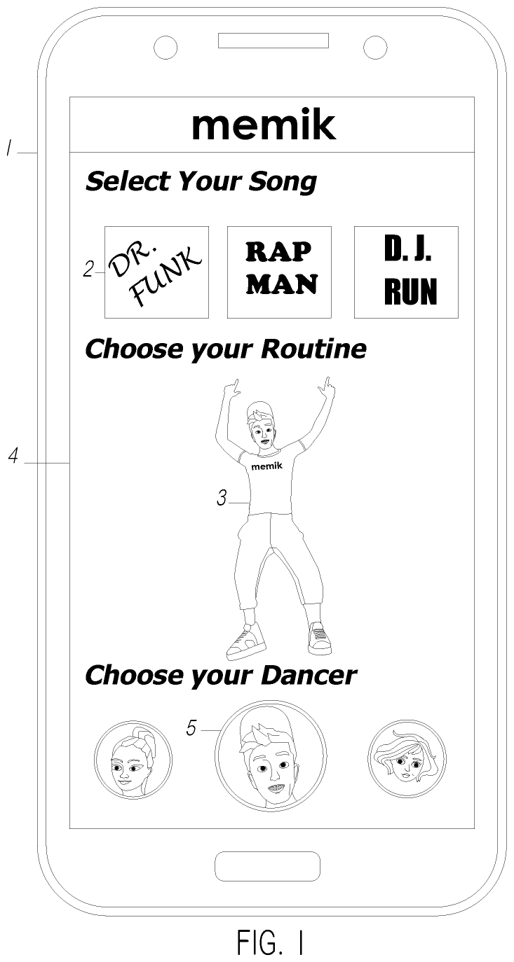

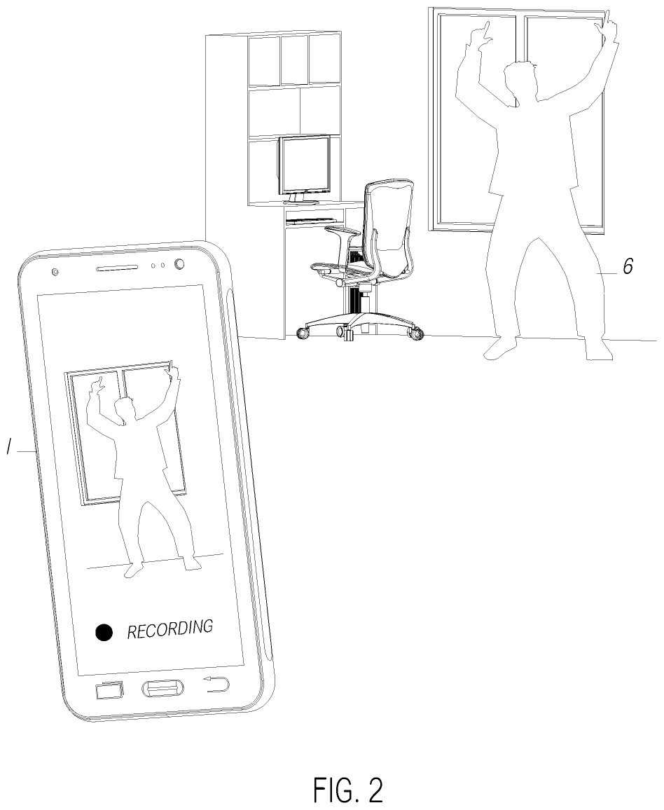

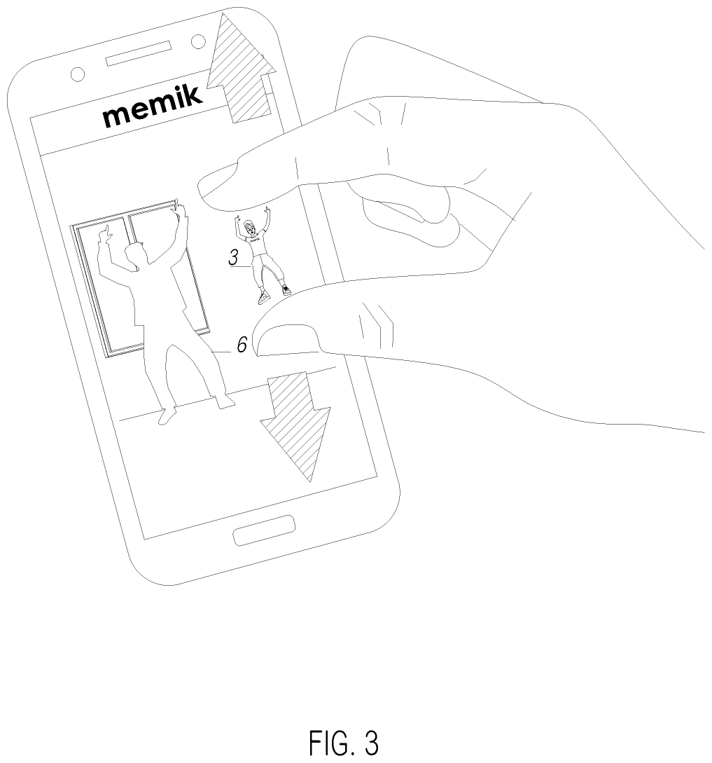

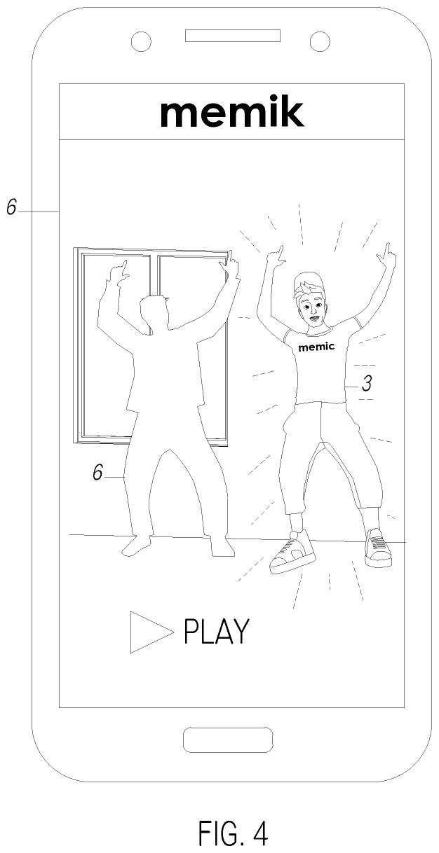

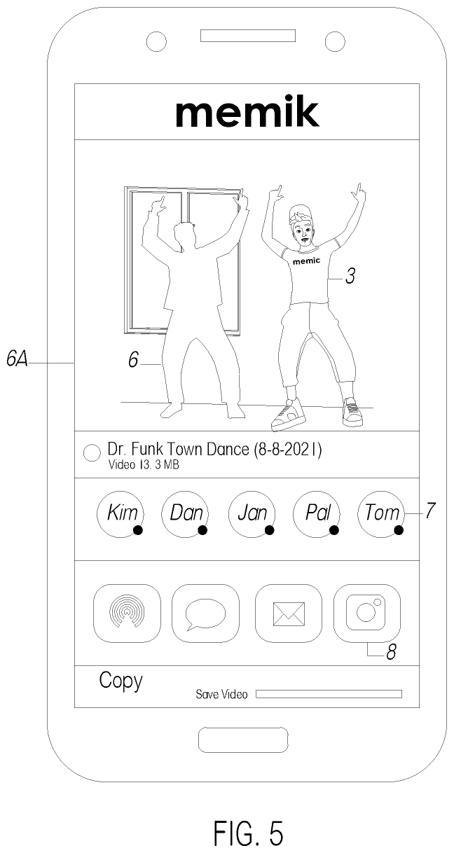

FIG. 1 shows a plan view of the preferred embodiment of the augmented reality platform app 4 used on a cell phone 1. The figure showing on-screen character avatar 3 selections wherein users can select from a plurality of preconfigured on-screen character avatars 3 such as but not limited to males, females, famous people, and popular animation characters etc. The also figure showing dance songs 2 available for users to choose from. The software having stock dance songs, on-screen character avatars, and dances users can choose from. Each dance is synced with said dance song beat and together, the dance song and dance are clipped to sub 20 second intervals. Other embodiments can use shorter or longer intervals. Other functions provided include but are not limited to music selection, dancing playback video, user profile, and settings (archives, dancing avatar sharing, dancing competition requests, AR activation, competition voting etc.). The app can also be used to apply various songs and dances to on-screen character avatars and the app syncs on-screen character avatar's movements with dance song beats. FIG. 2 shows a perspective view of a user 6 creating a video dance recording of themselves using the augmented reality platform app on a cell phone 1 and using said cell phone 6's onboard video camera. Once the footage of the user 6 is complete it is uploaded to a cloud network to undergo ‘memik-tization’— a process whereby artificial intelligence algorithms are used to export user 6 movements and save them as animation dance that can be applied to any on-screen character avatar in the future during a user recording session. Once exported, the video dance recording is transmitted back to the user's computing device and the user is able to select one of the app stock on-screen character avatars or use one that they've created with the customizer, resize it on their screen using their fingers on the touch screen as shown in FIG. 3. and place the on-screen character avatars into their local environment to initiate a dance recording. Users can also change on-screen character avatar features including but not limited to: facial elements, body type and clothing etc. FIG. 4 showing a dance challenge 6A whereby user 6 records their dancing footage with on-screen character avatar 3 superimposed thereon using augmented reality algorithms. Once completed, the user creating a dance challenge as shown in FIG. 5. The app allows users to post video dance recordings to the apps internal social feeds, share with to contacts 7 as well as forward them to popular social media platforms 8 including but not limited to: whatsapp, instagram and the like.

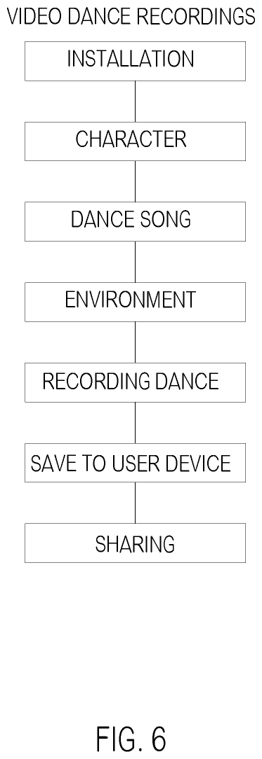

FIG. 6 shows a representative view of the augmented reality platform's methods of generating a video dance recording with stock dance songs and stock on-screen character avatars: users logging into the mobile app; downloading the app and installing the app on a computer device (such as a smart phone, tablet, and personal desktop computer etc.); selecting an on-screen character avatar; selecting a dance song; the app then records a dancing event with on-screen character avatar movements synced with said dance song's beat; said dancing event is then saved to a user's device; and user being allowed to share video dance recording with friends on social media platforms including but not limited to: whatsapp, instagram and the like.

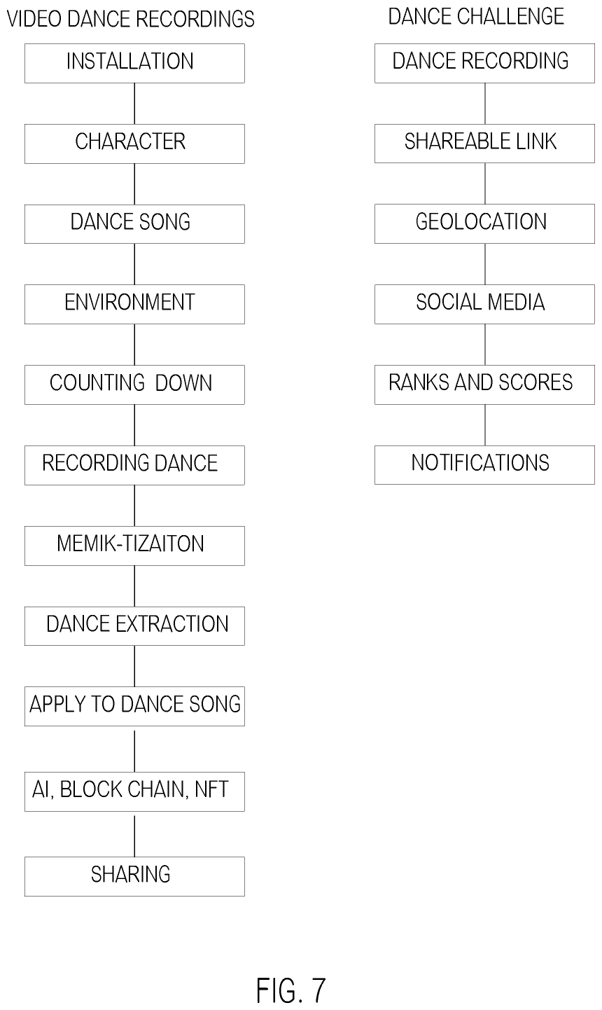

FIG. 7 shows a representative view of the augmented reality platform's methods of generating both video dance recordings and dance challenges: during on-screen character avatar generation; users logging into the mobile app; downloading the app and installing the app on a computer device (such as a smart phone, tablet, and personal desktop computer etc.); selecting an on-screen character avatar; selecting a dance song—this step can include uploading custom songs and uploading custom on-screen character avatars in which users overlay images of themselves onto on-screen character avatars; scanning the user's environment background (with a mobile device's existing camera); a countdown is enabled allowing a user to get ready to record—this step also includes the use of a pose detection algorithm that ensures the user is in frame; the app then records a dancing event (with a mobile device's existing camera); the dance event recording is uploaded to the cloud network for ‘memik-tization’ wherein AI is used to extract the user's motions and save them as a video dance recording which can then be applied to any on-screen character avatar in the system During this process, a block chain is established on the video dance recording with NFT and a globally unique identifier; the vide dance recording is streamed back to the user's mobile device and the user is allowed to create AR experiences in their host environment using that animation and song, along with any on-screen character avatar that exists in the mobile app.— this step also builds a choreography archive; and the user having access to play the video dance recording showing user and character avatar dancing together or individually. FIG. 7 also showing the dance challenge feature of the augmented reality platform that includes: recording a dance event using an existing mobile device's onboard camera and uploading it to the cloud network; receiving a shareable link of the video dance recording; observing potential friends within the area using an existing mobile device's geo location function; sending said video dance links, recording files and on-screen character avatars with friends and on popular social media websites such as but not limited to: Facebook, Instagram and the like—this step can also include selling video dance recordings using virtual currencies; the augmented reality platform tracking shares and likes of the video dance recording by using block chain ledgers; and receiving participation notifications relating to other, locally-based, dance challenges offered by using geo location detection—this feature allows users to unlock dance challenges when they are in the vicinity of a geofence as defined by another user.

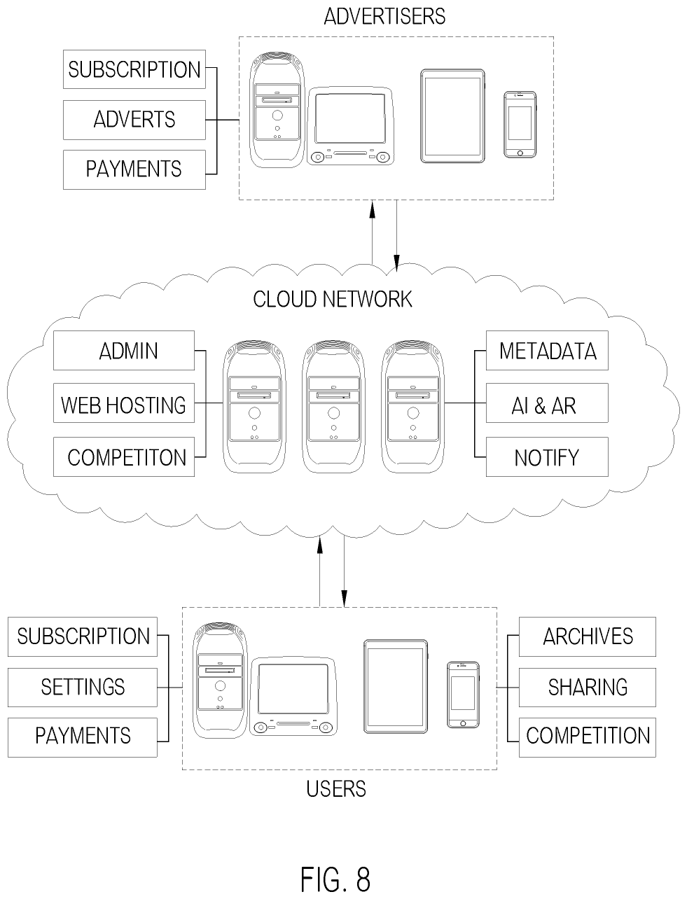

FIG. 8 showing the augmented reality platform process with functions available to advertisers such as but not limited to account subscription (contact information, subscription payments, notification preferences etc.); advertisement inclusion (banners, pop-up ads, discount listings etc.); and subscription payment options (Venlo, PayPal, etc.). The software also being compatible with a plurality of advertisers operating systems such as, but not limited to: Windows′, IOS, Android and compatible with a multitude of hardware platforms including, but not limited to: personal desktops, laptops, tablets, smartphones and the like. The figure showing the user having access to a multitude of operations including but not limited to: subscription services (user profile, demographics, subscription level, notification types etc.); settings (avatar selection, music selection, AR recordings, syncing dance routines with avatars, setting up dance competitions, establishing rewards etc.); payment options (Venmo, PayPal, virtual currencies etc.); archives (dancing avatar recording storage, competition results, customized avatar and music storage etc.); sharing operations (friends notifications, dancing avatar forwarding etc.); competition management (avatar dance voting and award selections etc.).

FIG. 8 also showing users and controllers connected by means of cloud network. Said cloud network having algorithms and routine operations such as but not limited to: administrative operations 8 (user demographics, venom, paypal payments etc.); website hosting (backend data management and encrypted archives, video streaming); competition operations (tracking sharing, real-time voting, dancing avatar displays among participants and geo location coordination); metadata (block chain assignments and NFT registrations); AI and AR operations (syncing user moves with avatar dances, predicting correlations between dance performance and music categories, environment overlays and the like); and user notifications 13 (SMS, text, email etc.).

Those of skill in the art will recognize that mobile applications are written in several languages include, by way of non-limiting examples, C, C++, C#, Objective-C, Java, Javascript, Pascal, Object Pascal, Python, Ruby, VB.NET, WML, and XHL/HL with or without CSS, or combinations thereof. The app in augmented reality platform 1 is also compatible with a plurality of operating systems such as, but not limited to: Windows, Apple, and Android, and compatible with a multitude of hardware platforms such as, but not limited to: personal desktops, laptops, tablets, smartphones and the like. Suitable mobile application development environments are available from several sources. Commercially available development environments include, by way of non-limiting examples, AirplaySDK, alcheMo, Appcelerator, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android SDK, BlackBerry SDK, BREW SDK, Palm OS SDK, Symbian SDK, webOS SDK, and Windows Mobile SDK. Those of skill in the art will recognize that several commercial forums are available for distribution of mobile applications including, by way of non-limiting examples, Apple App Store, Google Play, Chrome Web Store, BlackBerry App World, App Store for Palm devices, App Catalog for webOS, Windows Marketplace for Mobile, Ovi Store for Nokia devices, Samsung Apps, and Nintendo DSi Shop.

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™ Visual Basic, and VB .NET, or combinations thereof. Compilation is often performed, at least in part, to create an executable program. In some embodiments, a computer program includes one or more executable complied applications. In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe Flash Player, Microsoft Silverlight, and Apple QuickTime.

In view of the disclosure provided herein, those of skill in the art will recognize that several plug-in frameworks are available that enable development of plug-ins in various programming languages, including, by way of non-limiting examples, C++, Delphi, Java™, PHP, Python, and DOTNET, or combinations thereof. Web browsers (also called Internet browsers) are software applications, designed for use with network-connected digital processing devices, for retrieving, presenting, and traversing information resources on the World Wide Web. Suitable web browsers include, by way of non-limiting examples, Microsoft Internet Explorer, Mozilla Firefox, Google Chrome, Apple Safari, Opera Software Opera, and KDE Konqueror. In some embodiments, the web browser is a mobile web browser. Mobile web browsers (also called micro-browsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google Android browser, RIM BlackBerry Browser, Apple Safari, Palm Blazer, Palm WebOS Browser, Mozilla Firefox for mobile, Microsoft Internet Explorer Mobile, Amazon Kindle Basic Web, Nokia Browser, Opera Software Opera Mobile, and Sony PSP™ browser. Software Modules.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the augmented reality platform herein. As such those skilled in the art will appreciate the descriptions and depictions set forth in this disclosure or merely meant to portray examples of preferred modes within the overall scope and intent of the augmented reality platform, and are not to be considered limiting in any manner. While all of the fundamental characteristics and features of the augmented reality platform have been shown and described herein, with reference to particular embodiments thereof, a latitude of modification, various changes and substitutions are intended in the foregoing disclosure and it will be apparent that in some instances, some features of the augmented reality platform may be employed without a corresponding use of other features without departing from the scope of the augmented reality platform as set forth.

What is claimed is:

1. A non-transitory computer readable medium including computer readable instructions that, when executed by a computer, cause the computer to:
a) provide an augmented reality platform having on-screen character avatars with movements which are synced with a user's dance movements;
b) provide a video recording of the user and an environment background as the user performs dance movements;
c) provide dance songs for the user to perform dance movements to;
d) cause on-screen character avatars to be positioned in the environment background on the video recording; and
e) provide stock dance movements that are synced to dance song beats.

2. The non-transitory computer readable medium of claim 1, wherein:
a) the instructions cause the computer to provide the augmented reality platform having on-screen character avatars with movements which are synced with the user's dance movements with the use of artificial intelligence algorithms;
b) the instructions cause the computer to position on-screen avatars to be in the environment background with the use of augmented reality algorithms;
c) the instructions cause the computer to allow users to apply songs and dances to on-screen character avatars;
d) the instructions cause the computer to allow users to change on-screen character avatars' features;
e) the instructions cause the computer to sync on-screen character avatar's movements with dance song beats; and
the instructions cause the computer to clip songs into smaller sub minute intervals.

3. A method for generating video dance recordings comprised of the following steps:
a) logging into a server;
b) downloading and installing a software application;
c) selecting an on-screen character avatar;
d) selecting a dance song;
e) scanning an environment background;
f) waiting for a countdown;
g) recording a dancing event;
h) uploading the dance event to a cloud network;
i) extracting user dance movement into a video dance recording;
j) building a choreography archive;
k) establishing a block chain and a NFT;
l) streaming a video dance recording back to a user;
m) allowing users to apply dances to existing on-screen character avatars in their real world environments with resizing and scaling capabilities to match the scale of the environment background; and
n) playing the video dance recording.

4. The method for generating video dance recordings of claim 3, wherein the scanning the background environment includes the step of using a mobile device's existing camera.

5. The method for generating video dance recordings of claim 3, wherein the recording the dance event includes the step of using the mobile device's existing camera.

6. The method for generating video dance recordings of claim 3, wherein the transferring user motions onto on-screen character avatars includes the step of using AI algorithms.

7. The method for generating video dance recordings of claim 3, wherein the resizing the on-screen avatar to match the scale of the environment background includes the step of using fingers on the existing mobile device's screen.

8. The method for generating video dance recordings of claim 3, wherein the selecting an on-screen character avatar can also include the step of uploading custom on-screen character avatars.

9. The method for generating video dance recordings of claim 3, wherein the recording the dance event includes the step of detecting if a person is in frame using a pose detection algorithm.

10. A method for generating dance challenges comprising the following steps:
a) recording a dance event;
b) receiving a shareable link;
c) observing potential friends within the area;
d) sharing the video dance recording;
e) tracking shares and likes of the video dance recording; and
f) receiving participation notifications.

11. The method for generating dance challenges of claim 10, wherein the recording a dance event includes the step of using an existing mobile device's onboard camera and uploading the dance event to the cloud network.

12. The method for generating dance challenges of claim 10, wherein the observing potential users within the area includes the step of using the existing mobile device's geo location function.

13. The method for generating dance challenges of claim 10, wherein the sharing the video dance recording includes the step of sending the sharable links, on-screen character avatars and video dance recording files with friends and on popular social media websites and selling said video dance recordings with virtual currency.

14. The method for generating dance challenges of claim 10, wherein the tracking shares and likes of the video dance recording includes the step of using block chain ledgers.

15. The method for generating dance challenges of claim 10, wherein the receiving participation notifications includes the step of unlocking dance challenges when an established geofence detects another user in the vicinity of said geofence.
